(19) United States
(12) Patent Application Publication
(10) Pub. No.: US 2017/0024057 A1
(43) Pub. Date: Jan. 26, 2017

(54) Touch Screen and Electronic Device Using the Same

(71) Applicant: Nokia Technologies Oy, Espoo (FI)

(72) Inventors: Lei LI, Beijing (CN); Huipeng YANG, Beijing (CN); Jianying WEN, Beijing (CN); Enjie WANG, Beijing (CN)

(21) Appl. No.: 15/104,300

(22) PCT Filed: Dec. 20, 2013
(86) PCT No.: PCT/CN2013/090057

§ 371 Date: Jun. 14, 2016

(51) Int. Cl. G06F 3/041; G06F 3/044; G06F 1/32

(52) U.S. Cl. CPC G06F 3/0416; G06F 1/3262; G06F 3/044; G06F 3/0412; G06F 2203/04108

(57) ABSTRACT

Embodiments of the invention provide a touch screen. The touch screen includes a screen module composed of a plurality of constituent units, in which at least two constituent units are configured to be initially activated to detect proximity of at least one object, and a touch controller. The touch controller is configured to: periodically poll the at least two constituent units; upon detection of the proximity of the at least one object, degrade detection sensitivity of currently activated constituent units and activate other constituent units as the at least one object approaches the screen module; and calculate a location of the at least one object on the screen module based on the proximity detected by the currently activated constituent units.

### TECHNICAL FIELD

Embodiments of the invention generally relate to the field of electronic devices, and more specifically, to a partly polled touch screen and an electronic device using the same and to a method for controlling the touch screen.

### BACKGROUND

A conventional touch screen may comprise a screen module, a touch controller and a driver. The screen module may be divided into a plurality of constituent units. All of the constituent units are active and ready to be polled by the touch controller with a certain polling period so that the proximity of an object approaching the touch screen can be detected. However, for the conventional touch screen, since the polling activity is kept repeating periodically, all of the constituent units shall remain active even when there is no object approaching, which causes unnecessary power consumption.

Some solutions proposed for reducing the power consumption of the touch screen, for example as disclosed in Chinese patent application No. CN101105712A and Chinese patent No. CN101598986B, usually require extra control circuits to reduce the polling times, which need alterations to the existing hardware system and may result in a complicated circuitry.

### SUMMARY

Various embodiments of the invention aim at addressing at least part of the above problems and disadvantages. Other features and advantages of embodiments of the invention will also be understood from the following description of specific embodiments when read in conjunction with the accompanying drawings, which illustrate, by way of example, the principles of embodiments of the invention.

In a first aspect of the invention, there is provided a touch screen. The touch screen comprises a screen module composed of a plurality of constituent units, in which at least two constituent units are configured to be initially activated to detect proximity of at least one object, and a touch controller. The touch controller is configured to: periodically poll the at least two initially activated constituent units; upon detection of the proximity of the at least one object, degrade detection sensitivity of currently activated constituent units and activate other constituent units as the at least one object approaches the screen module; and calculate a location of the at least one object on the screen module based on the proximity detected by the currently activated constituent units.

In one embodiment, the at least two initially activated constituent units may be configured to be separate from each other and disposed along an edge of the screen module.

In one embodiment, when the proximity of the at least one object to the screen module is less than a threshold, all of the plurality of constituent units may be activated.

In one embodiment, the touch controller may be further configured to deactivate the currently activated constituent units.

In one embodiment, the touch controller may be configured to calculate a projective location of the at least one object on the screen module based on the proximity detected by the currently activated constituent units, prior to activating the other constituent units, and to activate the other constituent units based on the calculated projective location.

In one embodiment, the touch controller may be further configured to activate more constituent units around the currently activated constituent units, when the at least one object moves on the screen module.

In one embodiment, each of the plurality of constituent units may comprise a proximity sensor.

In a second aspect of the invention, there is provided an electronic device. The electronic device comprises a display panel, a touch screen coupled to the display panel, and a power supply. The touch screen comprises a screen module composed of a plurality of constituent units, in which at least two constituent units are configured to be initially activated to detect proximity of at least one object, and a touch controller. The touch controller is configured to: periodically poll the at least two initially activated constituent units; upon detection of the proximity of the at least one object, degrade detection sensitivity of currently activated constituent units and activate other constituent units as the at least one object approaches the screen module; and calculate a location of the at least one object on the screen module based on the proximity detected by the currently activated constituent units. The power supply is configured for supplying power to the display panel and the touch screen.

In a third aspect of the invention, there is provided a method for controlling a touch screen that comprises a plurality of constituent units, in which at least two constituent units are configured to be initially activated to detect proximity of at least one object. The method comprises: periodically polling the at least two initially activated constituent units; upon detection of the proximity of the at least one object, degrading detection sensitivity of currently activated constituent units and activating other constituent units as the at least one object approaches the touch screen; and calculating a location of the at least one object on the touch screen based on the proximity detected by the currently activated constituent units.

In a fourth aspect of the invention, there is provided a computer program product. The computer program product comprises at least one computer-readable storage medium having computer-executable program code instructions stored therein, the computer-executable program code instructions comprising program code instructions that, when being executed, performs the method according to the third aspect of the invention.

In a fifth aspect of the invention, there is provided a non-transitory computer-readable storage medium having computer-executable program code instructions stored therein, the computer-executable program code instructions comprising program code instructions that, when being executed, performs the method according to the third aspect of the invention.

### BRIEF DESCRIPTION OF THE DRAWINGS

The above and other aspects, features, and benefits of various embodiments of the invention will become more fully apparent, by way of example, from the following detailed description and the accompanying drawings, in which like reference numerals refer to the same or similar elements:

FIG. 1 illustrates a simplified structure and operations of a partly polled touch screen according to one embodiment of the invention;

FIG. 2 illustrates an example case where a touch screen is divided into a plurality of constituent units in a pattern different from the pattern as shown in FIG. 1;

FIG. 3 illustrates another example case where a touch screen is in a form of a scrolling bar;

FIG. 4 illustrates a simplified structure and operations of a partly polled touch screen according to one embodiment of the invention; and

FIG. 5 illustrates a flowchart of a method for controlling a touch screen according to one embodiment of the present invention.

### DETAILED DESCRIPTION

In the following description, numerous specific details are set forth. However, it shall be understood that embodiments of the invention may be practiced without these specific details. In the embodiments of the invention, well-known circuits, structures and techniques are not shown in detail in order not to obscure the understanding of this description. It will be appreciated, however, by one skilled in the art that the invention may be practiced in some instances without such specific details. Those of ordinary skills in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the following description and claims, the terms “coupled” and “connected,” along with their derivatives, may be used. It shall be understood that when an element is referred to as being “coupled” or “connected” to another element, it can be directly connected to the other element or intervening elements may be present.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### First Implementation

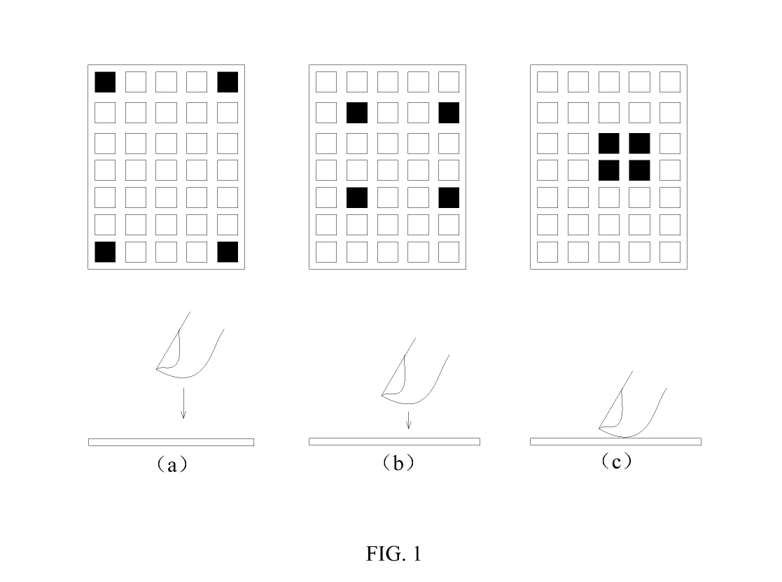

Reference is first made to FIG. 1, in which a simplified structure and operations of a partly polled touch screen according to one embodiment of the invention is illustrated. The partly polled touch screen, as an individual device, comprises a screen module that may be composed of a plurality of constituent units, for example in a pattern of 5×7 as illustrated in FIG. 1 and a touch controller configured for controlling operations on the constituent units. The term “partly polled” used herein means that at least two of the plurality of constituent units are activated to detect the proximity of an approaching object and ready to be polled by the touch controller during a polling period, while others of the plurality of constituent units are inactive and may not be polled by the touch controller.

In the illustrated embodiment, four constituent units located at four corners shown as black blocks in FIG. 1(a) are configured to be initially activated, e.g. upon power-on, while other constituent units are configured to be inactive, so that the touch controller can poll the four initially activated constituent units in every polling period so as to detect whether there is an approaching object, such as a finger, a pointer or a pen.

In one embodiment, each of the plurality of constituent units may comprise a proximity sensor, which may be of a capacitive type, inductive type, optical-electronic type, optical type and the like. The detection sensitivities of the four initially activated constituent units may be set to the highest so that any possible approaching object may be detected in time. “The highest” used herein means that the proximity sensors comprised in the initially activated constituent units are the most sensitive to detect the proximity of an approaching object.

Still in the illustrated embodiment, when there is an object approaching the screen module, the proximity of the object may be detected by the four initially activated constituent units and will be obtained by the touch controller during a poling period. Once the touch controller gets the detected proximity, it may roughly calculate a corresponding location of the object on the screen module based on the detected proximity. “The corresponding location” used herein may refer to a location of the object projected onto the screen module, i.e. the projective location. Then the touch controller may deactivate the initially activated (i.e. currently activated) four constituent units at the corners and meanwhile activate other four constituent units based on the calculated projective location of the object on the screen module, for example around the calculated location of the object on the screen module as shown in FIG. 1(b). At this point, the detection sensitivities of the newly activated four constituent units may be configured to be lower relative to the initially activated four constituent units so as to guarantee accuracy and save more power.

In one embodiment, the above described process, i.e. deactivating the currently (e.g. initially) activated constituent units and activating other constituent units, may be repeated until only four adjacent constituent units are activated as shown in FIG. 1(c). In other words, the touch controller may control the activated constituent units to gradually converge to the intended location of the object on the screen module. At this point, the proximity of the approaching object to the screen module is less than a predetermined threshold. In an extreme case, the object may have touched the touch screen. Then based on the proximity detected by the currently activated four adjacent constituent units, the location of the object on the screen module may be calculated by the touch controller.

During the object approaches the touch screen or after it has touched the touch screen, if the object moves away from the touch screen, for example the finger moves from the position as shown in FIG. 1(c) to the position as shown in FIG. 1(b), the activated constituent units will be dispersed, for example from four adjacent positions to four separate positions. That is, the deactivation/activation of the constituent units is performed in an order reverse to the order when the object is approaching the screen module.

In a case that the size of the approaching object is larger than four adjacent constituent units, there may be more than four constituent units to be activated at the last detection.

In one embodiment, if there is more than one object approaching the screen module, more than one group of the activated constituent units will be formed separately around each of the objects.

In one embodiment, if the object, such as a finger, is moving on the screen module, there may be more constituents units to be activated around the currently activated constituents units so as to detect the movement trend, and the group composed of the currently activated units will be moving along with the object movement.

Although in the embodiment as illustrated in FIG. 1, a number of the initially activated constituent units is four and the positions of them are located at the corners, it shall be understood that the number of the initially activated constituent units is not limited to four and the positions of them are not limited to the corners, and rather they are configurable according to application requirements.

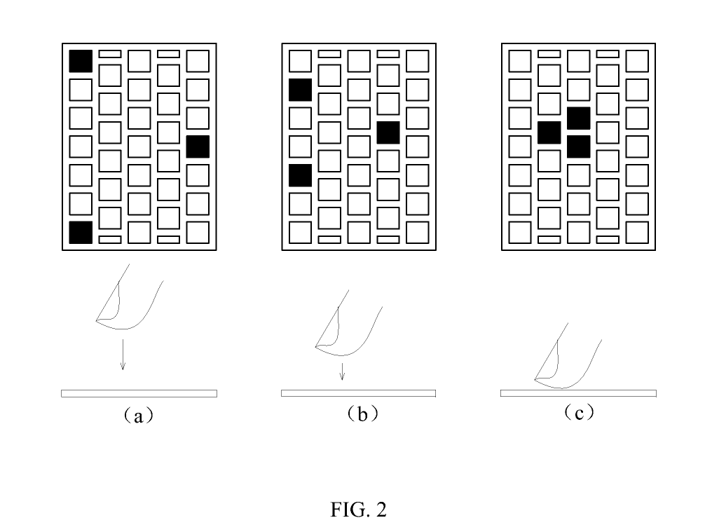

As an example, FIG. 2 illustrates a case where the screen module of a touch screen is composed of a plurality of constituent units in a pattern different from the pattern as shown in FIG. 1. In this example, the number of the initially activated constituent units may be three. The positions of the three activated constituent units may not be at the corners and alternatively along the edge of the screen module.

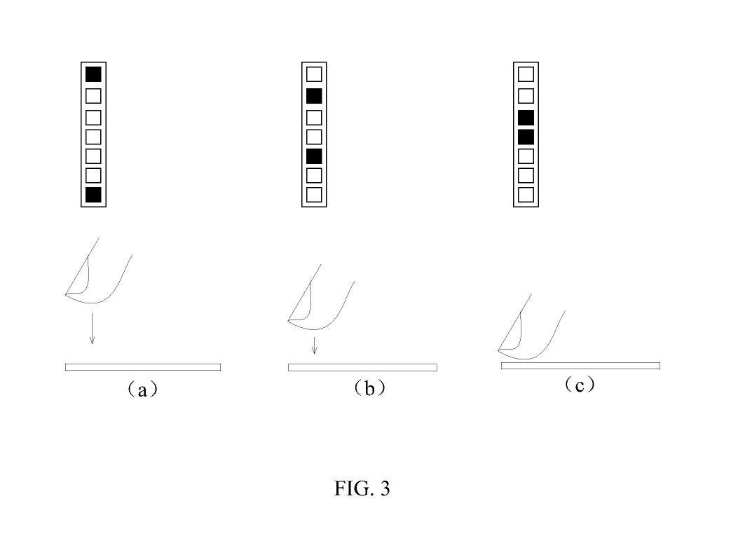

As another example, FIG. 3 illustrates a case where the screen module of a touch screen is in a form of a scrolling bar. In this case, the number of the initially activated constituent units may be two and they may be located at two corners.

### Second Implementation

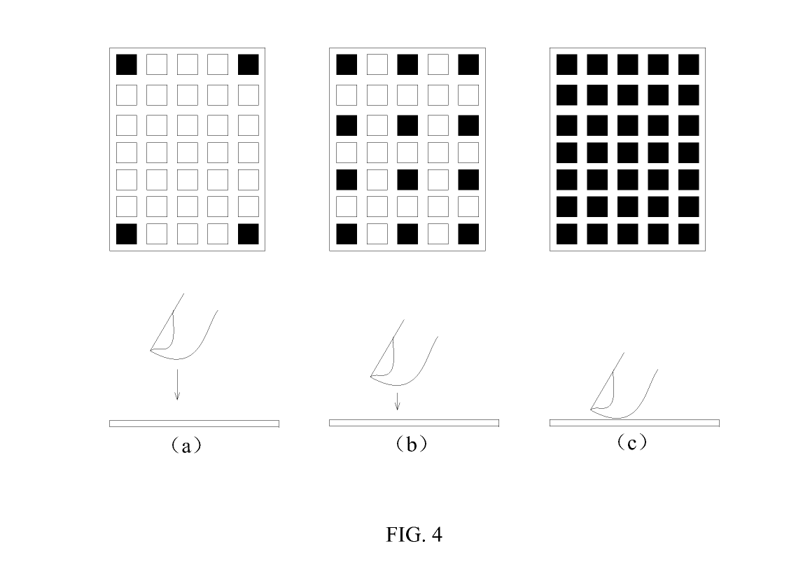

FIG. 4 illustrates a simplified structure and operations of a partly polled touch screen according to one embodiment of the present invention. The partly polled touch screen, as an individual device, comprises a screen module that may be composed of a plurality of constituent units, for example in a pattern of 5×7 as illustrated in FIG. 4 and a touch controller configured to control operations on the constituent units.

In the illustrated embodiment, four constituent units located at four corners shown as black blocks in FIG. 4 are configured to be initially activated, e.g. upon power-on, while other constituent units are configured to be inactive, so that the touch controller can poll the four initially activated constituent units in every polling period so as to detect whether there is an object approaching.

In one embodiment, each of the plurality of constituent units may comprise a proximity sensor, which may be of a capacitive type, inductive type, optical-electronic type, optical type and the like. The detection sensitivities of the four initially activated constituent units may be set to the highest so that any possible approaching object can be detected in time.

Still in the illustrated embodiment, when there is an object approaching, the proximity of the object may be detected by the four initially activated constituent units and will be obtained by the touch controller during a poling period. In this embodiment, after the touch controller gets the detected proximity, it does not need to roughly calculate the location of the object on the screen module. Instead, once the proximity of the approaching object is detected, the detection sensitivities of the initially activated (i.e. currently activated) constituent units will be degraded, while additional constituent units will be activated, as shown in FIG. 4 (b).

The detection sensitivities of the additionally activated constituent units may not be set higher than those of the currently (e.g. initially) activated constituent units so as to guarantee accuracy and save more power.

In one embodiment, the above described process, i.e. degrading the detection sensitivities of the currently activated constituent units and activating additional constituent units, will be repeated as the object approaches the screen module until all constituent units of the screen module are activated as shown in FIG. 4(c) and then the location of the approaching object on the screen module can be calculated. In other words, the touch controller may control the constituent units to be gradually activated. When all of the plurality of the constituent units is activated, the touch screen may operate as a conventional touch screen.

The touch screen according to embodiments of the present invention may be used in connection with a display panel, for example a liquid crystal panel, to form a touch-sensitive display screen. The display screen may be used in an electronic device, for example a portable terminal, such as a mobile phone, personal digital assistant (PDA), a gaming device, a GPS device, and the like. In the electronic device, the initial configuration of the touch screen may be executed when a power supply is turned on.

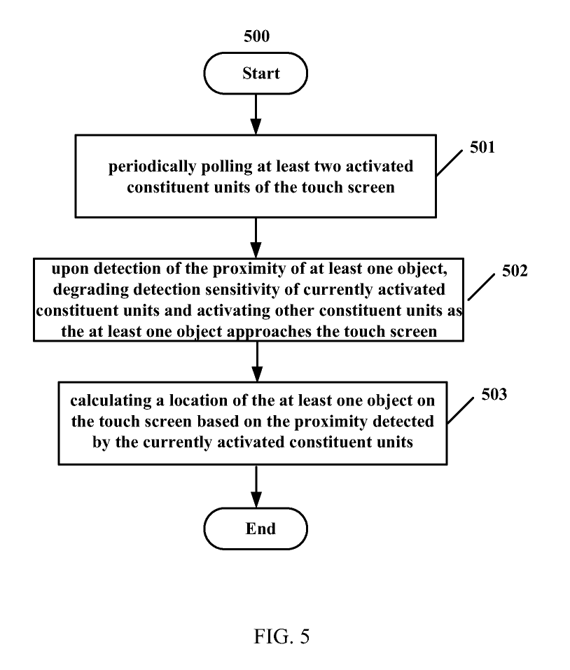

FIG. 5 illustrates a flowchart of a method for controlling a touch screen according to embodiments of the present invention. The touch screen comprises a plurality of constituent units, in which at least two constituent units are configured to be initially activated to detect proximity of at least one object.

In block 501, the at least two initially activated constituent units are periodically polled. In block 502, upon detection of the proximity of the at least one object, the detection sensitivity of currently activated constituent units are degraded and meanwhile other constituent units are activated as the at least one object approaches the touch screen.

In one embodiment, when the proximity of the at least one object to the touch screen is less than a threshold, for example, the at least one object touches the touch screen, all of the plurality of constituent units may be activated.

In another embodiment, the currently activated constituents units may be deactivated. During the process of block 502, prior to the other constituent units are activated, a projective location of the at least one object on the touch screen may be calculated based on the proximity detected by the currently activated constituent units, and then the other constituent units are activated based on the calculated projective location. For example, the constituent units around the calculated projective location may be activated. In this embodiment, the process in block 502 may be repeated until the proximity of the at least one object to the touch screen is less than a threshold distance, for example the at least one object touches the touch screen, as an extreme situation.

Then in block 503, the location of the at least one object on the touch screen is calculated based on the proximity detected by the currently activated constituent units. The location may be coordinates of the touch screen.

In one embodiment, the method 500 may further comprise activating more constituent units around the currently activated constituent units, when the at least one object moves on the touch screen.

It will be understood that each block and combinations of blocks in FIG. 5 may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus embody a mechanism for implementing the functions specified in the flowchart block(s). These computer program instructions may also be stored in a computer-readable storage medium (as opposed to a transmission medium such as a carrier wave or electromagnetic signal) that may direct a computer or other programmable apparatus to function in a particular manner, such that the instructions stored in the computer-readable memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIG. 5, when executed, convert a computer or processing circuitry into a particular machine configured to perform an example embodiment of the present invention.

Accordingly, blocks of the flowchart support combinations of means for performing the specified functions, combinations of operations for performing the specified functions and program instructions for performing the specified functions. It will also be understood that one or more blocks of the flowchart, and combinations of blocks in the flowchart, can be implemented by special purpose hardware-based computer systems which perform the specified functions or operations, or combinations of special purpose hardware and computer instructions.

Exemplary embodiments of the present invention have been described above with reference to schematic diagrams and flowchart illustrations of methods. It will be understood that each block of the flowchart illustrations, and combinations of blocks in the flowchart illustrations, respectively, can be implemented by various means, not limited to any specific embodiment as disclosed.

While this specification contains many specific implementation details, these should not be construed as limitations to the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

1. A touch screen, comprising:
a screen module composed of a plurality of constituent units, wherein at least two of the plurality of constituent units are configured to be initially activated to detect proximity of at least one object; and
a touch controller configured to:
periodically poll the at least two initially activated constituent units;
upon detection of the proximity of the at least one object, degrade detection sensitivity of currently activated constituent units and activate other constituent units as the at least one object approaches the touch screen; and
calculate a location of the at least one object on the screen module based on the proximity detected by the currently activated constituent units.

2. The touch screen according to claim 1, wherein the at least two initially activated constituent units are configurable to be separate from each other and disposed along an edge of the screen module.

3. The touch screen according to claim 1 or 2, wherein when the proximity of the at least one object to the screen module is less than a threshold, the plurality of constituent units are activated.

4. The touch screen according to claim 1 or 2, wherein the touch controller is further configured to deactivate the currently activated constituent units.

5. The touch screen according to claim 4, wherein the touch controller is configured to:
prior to activating the other constituent units, calculate a projective location of the at least one object on the screen module based on the proximity detected by the currently activated constituent units, and
activate the other constituent units based on the calculated projective location.

6. The touch screen according to claim 5, wherein the touch controller is further configured to:
activate more constituent units around the currently activated constituent units, when the at least one object moves on the screen module.

7. The touch screen according to claim 1, wherein each of the plurality of constituent units comprises a proximity sensor.

8. An electronic device, comprising:
a display panel;
a touch screen coupled to the display panel, comprising:
a screen module composed of a plurality of constituent units, wherein at least two of the plurality of constituent units are configured to be initially activated to detect proximity of at least one object; and
a touch controller configured to:
periodically poll the at least two constituent units;
upon detection of the proximity of the at least one object, degrade detection sensitivity of currently activated constituent units and activate other constituent units as the at least one object approaches the screen module; and
calculate a location of the at least one object on the screen module based on the proximity detected by the currently activated constituent units; and
a power supply for supplying power to the display panel and the touch screen.

9. The electronic device according to claim 8, wherein the at least two initially activated constituent units are configurable to be separate from each other and disposed along an edge of the screen module.

10. The electronic device according to claim 8, wherein when the proximity of the at least one object to the screen module is less than a threshold, the plurality of constituent units are activated.

11. The electronic device according to claim 8, wherein the touch controller is further configured to deactivate the currently activated constituent units.

12. The electronic device according to claim 11, wherein the touch controller is configured to:
prior to activating the other constituent units, calculate a projective location of the at least one object on the screen module based on the proximity detected by the currently activated constituent units, and
activate the other constituent units based on the calculated projective location.

13. The electronic device according to claim 12, wherein the touch controller is further configured to:
activate more constituent units around the currently activated constituent units, when the at least one object moves on the screen module.

14-15. (canceled)

16. A method for controlling a touch screen that comprises a plurality of constituent units, wherein at least two of the plurality of constituent units are configured to be initially activated to detect proximity of at least one object, the method comprising:
periodically polling the at least two constituent units;
upon detection of the proximity of the at least one object, degrading detection sensitivity of currently activated constituent units and activating other constituent units as the at least one object approaches the touch screen; and
calculating a location of the at least one object on the touch screen based on the proximity detected by the currently activated constituent units.

17. The method according to claim 16, wherein the at least two initially activated constituent units are configurable to be separate from each other and disposed along an edge of the touch screen.

18. The method according to claim 16, wherein when the proximity of the at least one object to the touch screen is less than a threshold, the plurality of constituent units are activated.

19. The method according to claim 16, wherein degrading the detection sensitivity of the currently activated constituent units further comprises deactivating the currently activated constituent units.

20. The method according to claim 19, further comprising:
prior to activating the other constituent units, calculating a projective location of the at least one object on the touch screen based on the proximity detected by the currently activated constituent units, and
activating the other constituent units based on the calculated projective location.

21. The method according to claim 20, further comprising:
activating more constituent units around the currently activated constituent units, when the at least one object moves on the touch screen.

22. A computer program product comprising at least one non-transitory computer-readable storage medium having computer-executable program code instructions stored therein, the computer-executable program code instructions, when being executed, perform the method of claim 16.
